(19) United States
(12) Patent Application Publication
(10) Pub. No.: US 2026/0319117 A1
(43) Pub. Date: Oct. 15, 2026

(54) METHOD AND COMPUTING SYSTEM FOR DETERMINING STRATIGRAPHIC LAYERS OF A GEOLOGICAL FORMATION

(71) Applicant: TotalEnergies OneTech, Courbevoie (FR)

(72) Inventors: Lionel Boillot, Pau (FR); Alexandre Krajnc-Giroud, Pau (FR)

(21) Appl. No.: 19/485,206

(22) PCT Filed: Jun. 1, 2023
(86) PCT No.: PCT/IB2023/000293

§ 371 Date: Nov. 17, 2025

(51) Int. Cl. G01V 1/30; G01V 20/00; G06N 3/08

(52) U.S. Cl. CPC G01V 1/301; G01V 20/00; G06N 3/08; G01V 2210/641

(57) ABSTRACT

A computer-implemented method for determining stratigraphic layers of a geological formation includes determining stratigraphic image which corresponds to a stacking of estimated stratigraphic layers, splitting the estimated stratigraphic layers into different pieces and setting a reference slice composed of a stacking of reference pieces of estimated stratigraphic layers, determining a reference piece mapping model, for each other piece among a plurality of other pieces of estimated stratigraphic layers: mapping the other piece with one reference piece among the reference pieces of the reference slice, by applying the reference piece mapping model, and for each reference piece: determining a stratigraphic layer of the geological formation by grouping the considered reference piece with each piece mapped with the considered reference piece.

### BACKGROUND

### Technical Field

The present disclosure relates to the processing of seismic images of a geological formation in order to derive information that may be used for analyzing the geological formation and for exploiting the geological formation (e.g., for determining if and how the geological formation can be used for hydrocarbon recovery and/or for carbon dioxide storage).

### Description of the Related Art

It is known, especially in hydrocarbon exploration, to determine the position of oil reservoirs from the results of seismic measurements carried out from the surface or in well bores.

According to the technology of reflection seismology, these seismic measurements involve emitting a wave (e.g., acoustic waves) into the subsurface and measuring a signal comprising a plurality of echoes of the wave on geological structures of the geological formation.

These geological structures are typically surfaces separating distinct stratigraphic layers, faults, etc. Other measurements may be carried out at wells bores.

Chrono-stratigraphic analysis is very important to understand basin evolution, predict the sedimentary facies distribution for both hydrocarbon exploration and development. This analysis is based on the fundamental assumption that seismic reflectors are surfaces of chrono-stratigraphic significance. This assumption implies that an individual seismic reflector is a “time-line” through a depositional basin that represents a surface of the same geological age (i.e., an isochronous surface in geological time).

A seismic image comprises a juxtaposition in a volume of sampled one-dimensional signals referred to as seismic traces. In a seismic trace, the value of a pixel (a.k.a. voxel for 3D images) is representative of the amplitude of the seismic measurement obtained for the portion of the geological formation represented by this pixel.

Such a seismic image may be used (possibly in combination with other information) to compute a stratigraphic image of the geological formation, i.e., to compute a representation of a stacking of estimated stratigraphic layers composing said geological formation. Determining such a stratigraphic image usually relies on estimating isochronous surfaces of the geological formation, based on the seismic image.

For instance, Lomask et al., “Flattening without picking”, Geophysics, Volume 71, Issue 4 (July-August 2006), pp. 13-20, describes a method for determining seismic horizon surfaces based on a seismic image, by computing the local seismic dip at each pixel of the seismic image and searching iteratively for surfaces having local gradients approaching the local seismic dips. Such seismic horizon surfaces are examples of estimated isochronous surfaces.

Such seismic horizon surfaces can further be used to determine a relative geological time (RGT) image of the geological formation, i.e., an image in which each pixel provides an estimated geological age for the portion of the geological formation represented by said pixel. The RGT image is referred to as “relative” because the purpose of the RGT image is mainly to be able to compare the estimated geological ages of different pixels, in order to, e.g., identify portions of the geological formation that have the same estimated geological age. Also, in practice, it is usually not possible to estimate an absolute geological age of any given portion of the geological formation. An RGT surface, i.e., a set of points of the RGT image which correspond to pixels having the same estimated geological age in said RGT image, is also an example of estimated isochronous surface.

Such estimated isochronous surfaces can be used to determine estimated stratigraphic layers of the geological formation. For instance, an estimated stratigraphic layer may be defined between two particular estimated isochronous surfaces which are considered to represent strong seismic reflectors (e.g., associated to high amplitude seismic values of the seismic traces), whereby strong seismic reflectors are likely to correspond to interfaces between different real stratigraphic layers of the geological formation. More precisely, such estimated isochronous surfaces can be used to estimate a geometry of said real stratigraphic layers. Other characteristics of the real stratigraphic layers, e.g., the sedimentary facies of each real stratigraphic layer, are determined by using other methods.

Existing methods for identifying estimated stratigraphic layers of the geological formation (in terms of geometry) based on a seismic image of said geological formation perform usually well, except in the presence of stratigraphic discontinuities (e.g., fault, salt dome, etc.). Indeed, existing methods usually rely on an assumption of lateral continuity which does not hold anymore in the presence of such stratigraphic discontinuities. For instance, the real stratigraphic layers may be shifted vertically from one side of a fault to the other side. However, existing methods do not handle such vertical shifts, resulting in estimated stratigraphic layers which extend laterally through the fault. Hence, the estimated stratigraphic layers may be composed of pieces which belong in fact to different real stratigraphic layers, which biases the analysis of the geological formation.

### BRIEF SUMMARY

The present disclosure aims at improving the situation. In particular, the present disclosure aims at addressing at least some of the limitations of the prior art discussed above. In particular, the present disclosure aims at proposing a solution for improving the automatic determination of stratigraphic layers of a geological formation in the presence of stratigraphic discontinuities such as faults, salt domes, etc.

For this purpose, and according to a first aspect, the present disclosure relates to a computer implemented method for determining stratigraphic layers of a geological formation, based on a seismic image which comprises seismic values obtained from seismic measurements carried out on the geological formation, wherein said method comprises:
determining a stratigraphic image of the geological formation by processing the seismic image, wherein the stratigraphic image corresponds to a stacking of estimated stratigraphic layers,
splitting the estimated stratigraphic layers of the stratigraphic image into different pieces and setting a reference slice composed of a stacking of pieces of estimated stratigraphic layers, referred to as reference pieces,
determining a reference piece mapping model based on the seismic values of portions of the seismic image which correspond to the reference pieces of the reference slice, for each other piece among a plurality of other pieces of estimated stratigraphic
layers: mapping (S23) said other piece with one reference piece among the reference pieces of the reference slice, by applying the reference piece mapping model to at least the seismic values of a portion of the seismic image which corresponds to the considered other piece of estimated stratigraphic layer,
for each reference piece: determining a stratigraphic layer of the geological formation by grouping the considered reference piece with each other piece mapped with said considered reference piece.

Hence, the proposed solution relies on a stratigraphic image which may be determined by using any method known to the skilled person. The stratigraphic image corresponds to a stacking of estimated stratigraphic layers of the geological formation.

A part of this stratigraphic image, referred to as reference slice, is used as a reference for characterizing the respective contents of the real stratigraphic layers of the geological formation. In the present disclosure, a slice corresponds to a local (vertical) stacking of pieces of estimated stratigraphic layers of the stratigraphic image. The pieces of estimated stratigraphic layers of the reference slice are considered as reference pieces, which are assumed to belong to different respective real stratigraphic layers. Then, the proposed solution aims at identifying other pieces of estimated stratigraphic layers of the stratigraphic image, outside the reference slice, which can be considered to belong to a same real stratigraphic layer as each of the reference pieces, without any lateral continuity assumption. The slices are set by, e.g., splitting the estimated stratigraphic layers in pieces. For instance, the estimated stratigraphic layers may be split in pieces based on, e.g., stratigraphic discontinuities, and a slice may be delimited laterally by one or more stratigraphic discontinuities. The reference slice may for instance correspond to the stacking of (reference) pieces of estimated stratigraphic layers on one side of a fault, which is used for mapping other pieces of estimated stratigraphic layers on the other side of the fault with respective reference pieces of the reference slice.

Based on the reference slice and based on the seismic values of the seismic image obtained for the part of the geological formation which corresponds to the reference slice, a reference piece mapping model is determined. The reference piece mapping model corresponds to a function which outputs (predicts), for a fragment of the geological formation, a mapping with one of the reference pieces based on input seismic values obtained for at least said fragment of the geological formation. The reference piece mapped with the considered fragment corresponds for instance to the reference piece, among all reference pieces of the reference slice, which most likely belongs to a same real stratigraphic layer as the considered fragment. In some cases, the reference piece mapping model may output respective likelihoods for all reference pieces of the reference slice, and the reference piece mapped with the considered fragment corresponds for instance to the reference piece having the greatest likelihood associated thereto.

The reference piece mapping model is then applied to other pieces of estimated stratigraphic layers, to obtain mappings between the reference pieces and each other piece of a plurality of other pieces of estimated stratigraphic layers. By “other piece”, we mean a piece of estimated stratigraphic layer that is not a reference piece (i.e., that does not belong to the reference slice). For instance, if the reference pieces and the other pieces are on either side of a fault, then it is possible to identify pieces of estimated stratigraphic layers on either side of this fault which correspond to a same real stratigraphic layer. It is emphasized that, while lateral continuity is ignored at this stage (i.e., pieces of estimated stratigraphic layers which belong to a same real stratigraphic layer are not necessarily in lateral continuation of each other) the upper and lower boundaries of the pieces of estimated stratigraphic layers are kept, since they correspond to strong seismic reflectors which are usually well retrieved. Hence, a piece of estimated stratigraphic layer corresponds for instance to a piece that is laterally bounded by one or more stratigraphic discontinuities (and possibly by the boundaries of the stratigraphic image itself) and that is vertically bounded by the boundaries with other estimated stratigraphic layers of the stratigraphic image.

Then, each stratigraphic layer is determined by grouping together the pieces of estimated stratigraphic layers considered to belong to a same real stratigraphic layer of the geological formation.

In some embodiments, the method can further comprise one or more of the following optional features, considered either alone or in any technically possible combination.

In some embodiments, the reference slice is at least partially delimited by at least one stratigraphic discontinuity of the geological formation.

In some embodiments, the method comprises detecting stratigraphic discontinuities of the geological formation by processing the seismic image and splitting the estimated stratigraphic layers into different pieces based on the detected stratigraphic discontinuities.

In some embodiments, the stratigraphic discontinuities comprise faults and the reference slice is at least partially delimited by at least one fault of the geological formation.

In some embodiments, the reference piece mapping model corresponds to a machine learning model trained by using, as training data, the seismic values of portions of the seismic image which correspond to the reference pieces of the reference slice.

In some embodiments, the machine learning model corresponds to a neural network (NN).

In some embodiments, the machine learning model corresponds to a physics-informed neural network (PINN) trained to predict mappings with reference pieces which are compatible with a stacking order of the reference pieces in the reference slice, referred to as reference stacking order.

In some embodiments, during training, the PINN applies a vertical filter on predicted mappings with reference pieces to produce filtered values representative of a compatibility with the reference stacking order, and the PINN is trained to predict mappings with reference pieces for which the obtained filtered values are representative of a stacking order of the predicted mappings that is compatible with the reference stacking order.

In some embodiments, mapping another piece of estimated stratigraphic layer with a reference piece comprises:
mapping a plurality of different subpieces of said other piece with respective reference pieces of the reference slice, by using the reference piece mapping model,
determining the mapping for said other piece based on the mappings determined for the subpieces of said other piece.

In some embodiments, the method comprises using the determined stratigraphic layers for hydrocarbon recovery from the geological formation and/or for carbon dioxide storage in said geological formation. For instance, the determined stratigraphic layers may be used to perform at least one among: (i) predicting an amount of hydrocarbon that may be recovered from the geological formation, and (ii) predicting an amount of carbon dioxide that may be stored in the geological formation.

In some embodiments, the method comprises displaying the determined stratigraphic layers by using a visual display unit.

According to a second aspect, the present disclosure relates to a computer program product comprising instructions which, when executed by at least one processor, configure said at least one processor to carry out a method according to any one of the embodiments of the present disclosure.

According to a third aspect, the present disclosure relates to a computer-readable storage medium comprising instructions which, when executed by at least one processor, configure said at least one processor to carry out a method according to any one of the embodiments of the present disclosure.

According to a fourth aspect, the present disclosure relates to a computing system comprising at least one memory and at least one processor configured to carry out a method according to any one of the embodiments of the present disclosure.

### BRIEF DESCRIPTION OF THE SEVERAL VIEWS OF THE DRAWINGS

The disclosure will be better understood upon reading the following description, given as an example that is in no way limiting, and made in reference to the figures which show:

FIG. 1 depicts an example of seismic image,

FIG. 2 is a flow chart illustrating an example of method for determining stratigraphic layers of a geological formation,

FIG. 3 depicts an example of stratigraphic image obtained from the seismic image of FIG. 1,

FIG. 4 depicts examples of faults detected in the seismic image of FIG. 1,

FIG. 5 depicts examples of pieces of estimated stratigraphic layers obtained by splitting the stratigraphic image of FIG. 3 based on the faults of FIG. 4,

FIG. 6 depicts an example of a reference slice composed of reference pieces,

FIG. 7 depicts examples of mappings obtained by applying a reference piece mapping model to a slice of the stratigraphic image that is adjacent to the reference slice,

FIG. 8 depicts examples of mappings obtained for the pieces of the slice of the stratigraphic image that is adjacent to the reference slice.

In these figures, reference numerals identical from one figure to another designate identical or analogous elements. For reasons of clarity, the elements shown are not to scale, unless explicitly stated otherwise.

Also, the order of steps or phases represented in the figures is provided only for illustration purposes and is not meant to limit the present disclosure which may be applied with the same steps or phases executed in a different order.

### DETAILED DESCRIPTION

As discussed above, the present disclosure relates inter alia to a computer implemented method 20 for determining stratigraphic layers of a geological formation, based on a seismic image of the geological formation.

A seismic image represents a picture of the subsoil arising from a seismic exploration survey. The seismic image comprises at least two dimensions which may comprise at least one horizontal dimension (which usually uses a distance scale, expressed, e.g., in meters) and one vertical dimension (which usually uses a distance scale or a time scale, expressed, e.g., in seconds). Hence, the seismic image may correspond to a three-dimensional (3D) seismic image (with two horizontal dimensions and one vertical dimension) or to a two-dimensional (2D) seismic image (with one horizontal dimension and one vertical dimension).

It is emphasized that the expressions “horizontal dimension” and “vertical dimension” are not to be interpreted as requiring these dimensions to be respectively strictly horizontal and strictly vertical. These expressions mean that one of the dimensions, referred to as “vertical dimension”, generally extends along the depth of the geological formation, and that the other dimensions, referred to as “horizontal dimensions” are both orthogonal to the vertical dimension.

The seismic image is composed of pixels which may be 2D in case of a 2D seismic image or 3D (voxels) in case of a 3D seismic image. In some examples, the pixels are regularly distributed according to a horizontal resolution on each horizontal dimension and a vertical resolution on the vertical dimension. The seismic image comprises, along each horizontal dimension:

a number of columns of pixels which is equal to the quotient of the horizontal extension along this horizontal dimension divided by the horizontal resolution along this horizontal dimension; each column of the seismic image may be referred to as “seismic trace”; and a number of pixels per column which is equal to the quotient of the vertical extension divided by the vertical resolution.

Each pixel is associated with a seismic value which is representative of the amplitude of the seismic signal measured for the portion of the geological formation represented by the corresponding pixel.

In the sequel, a point corresponds to a set of coordinates in the grid of the seismic image, i.e., a set comprising a horizontal position along each horizontal dimension and a vertical position along the vertical dimension. A pixel therefore corresponds to a point with a value associated thereto (i.e., a seismic value in the case of a pixel of the seismic image, an estimated geological age in the case of a pixel of an RGT image, etc.).

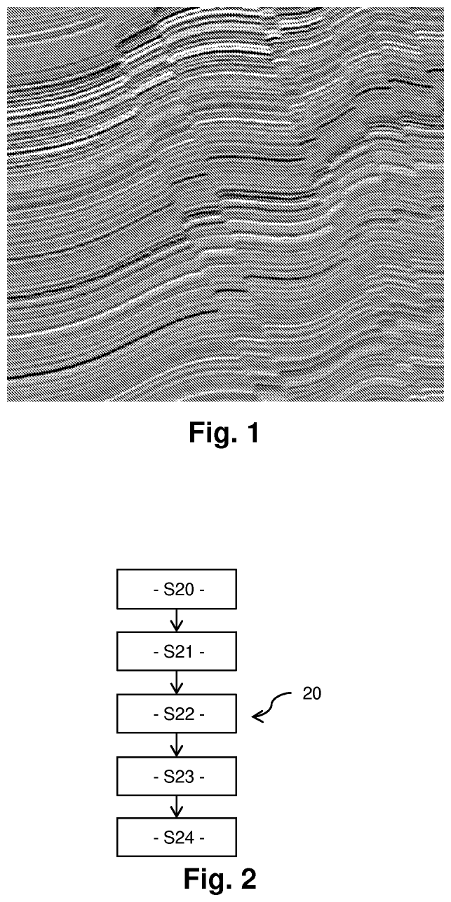

FIG. 1 represents an example of seismic image. The seismic image represented by FIG. 1 is 2D and may correspond to a 2D seismic image or to a 2D section of a 3D seismic image, in a vertical plane. As can be seen in FIG. 1, the seismic values highlight the composition of the geological formation, since high amplitude seismic values are usually associated to strong seismic reflectors. The present disclosure applies for 2D seismic images and for 3D seismic images.

FIG. 2 represents schematically an exemplary embodiment of a method 20 for determining stratigraphic layers of a geological formation.

The determining method 20 is carried out by a computing system (not represented in the figures). In some examples, the computing system comprises one or more processors (which may belong to a same computer or to different computers) and one or more memories (which may belong to a same computer or to different computers). The one or more processors may include for instance a central processing unit (CPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors in order to implement all or part of the steps of the determining method 20.

In other words, the computing system comprises a set of means configured by software (specific computer program product) and/or by hardware (CPU, DSP, FPGA, ASIC, etc.) to implement the steps of the determining method 20.

As illustrated by FIG. 2, the determining method 20 comprises a step S20 of determining a stratigraphic image of the geological formation, by processing the seismic image. A stratigraphic image corresponds to a stacking of estimated stratigraphic layers of the geological formation.

As discussed above, a stratigraphic image may, for example, be determined based on estimated isochronous surfaces of the geological formation. An estimated isochronous surface corresponds to the points of the seismic image of pixels which represent portions of the geological formation which are considered to have the same geological age.

For example, estimated isochronous surfaces are determined by the computing system, based on the seismic image. Seismic horizon surfaces, which may be determined by the computing system as described in Lomask et al., “Flattening without picking”, Geophysics, Volume 71, Issue 4 (July-August 2006), pp. 13-20, or in the patents EP 3978960 or FR 2869693, etc., are examples of estimated isochronous surfaces.

Also, such seismic horizon surfaces can be used to determine an RGT image of the geological formation. In an RGT image, each pixel provides an estimated geological age for the portion of the geological formation represented by said pixel. An RGT image may therefore be used to obtain RGT surfaces which are also examples of estimated isochronous surfaces. For example, an RGT image may be determined by the computing system as described in the patent application publication WO 2022/157531.

In general, RGT surfaces are more accurate than seismic horizon surfaces, since an RGT image is computed by using a large number of seismic horizon surfaces, thereby mitigating potential inaccuracies of some seismic horizon surfaces. Hence, using an RGT surface for the isochronous surface corresponds to an advantageous example of the present disclosure.

As indicated above, such estimated isochronous surfaces can be used to determine estimated stratigraphic layers of the geological formation. For instance, an estimated stratigraphic layer may be defined between two particular estimated isochronous surfaces which are considered to represent strong seismic reflectors (e.g., associated to high amplitude seismic values of the seismic traces), whereby strong seismic reflectors might correspond to interfaces between different real stratigraphic layers of the geological formation.

For example, it is possible to determine a set of estimated isochronous surfaces which comprises a large number of estimated isochronous surfaces (such that possibly many estimated isochronous surfaces might be included in a same real stratigraphic layer, i.e., they might not correspond to interfaces between real stratigraphic layers), and to select a subset of estimated isochronous surfaces. For example, the subset of estimated isochronous surfaces may include the estimated isochronous surfaces associated to the highest seismic values of the seismic traces.

Indeed, each estimated isochronous surface corresponds to the points of the seismic image which represent portions of the geological formation which are considered to have the same geological age. For each estimated isochronous surface, it is therefore possible to obtain all the seismic values of the pixels positioned on the considered estimated isochronous surface. It is therefore possible, for each estimated isochronous surface, to identify its own maximum seismic value associated thereto. For example, the subset of estimated isochronous surfaces may be composed of each estimated isochronous surface having a maximum seismic value associated thereto that is greater than a predetermined threshold. The subset of estimated isochronous surfaces may then be used to delimit the estimated stratigraphic layers of the stratigraphic image, wherein each stratigraphic layer corresponds for example to the volume bounded by two estimated isochronous surfaces of the subset having no intermediate estimated isochronous surface between them in the subset.

Generally speaking, the determination of the stratigraphic image may use any method known to the skilled person and is not limited to the above examples. The goal is to obtain a stacking of estimated stratigraphic layers.

As discussed previously, the presence of stratigraphic discontinuities in the geological formation impacts the real stratigraphic layers which, for example, may be shifted vertically from one side of a fault to the other side. This is visible also in FIG. 1, where it can be seen that the seismic image comprises lines of high seismic values that are discontinuous, which is likely caused by the presence of a fault. As a consequence, each estimated stratigraphic layer may be composed laterally (i.e., along the horizontal dimension) of pieces which belong in fact to different real stratigraphic layers. Along the depth of the geological formation (i.e., along the vertical dimension), each piece of estimated stratigraphic layer belongs typically to a single real stratigraphic layer (i.e., it has a thickness that is lower or equal than the local thickness of the real stratigraphic layer it belongs to).

For example, the estimated stratigraphic layers are determined such that each real stratigraphic layer is represented, along the depth of the geological formation, by more than one estimated stratigraphic layer.

For example, this may be obtained by adjusting (i.e., reducing) the threshold used for selecting the subset of estimated stratigraphic layers.

Alternatively, or in combination thereof, another example uses predetermined seeds, distributed throughout the seismic image (horizontally and vertically), which correspond to points for which estimated isochronous surfaces need to be determined (i.e., each seed needs to belong to an estimated isochronous surface) and used for determining the estimated stratigraphic layers. Such seeds may for instance be determined automatically, by selecting a subset of seismic traces of the seismic image (for example regularly and/or randomly distributed throughout the seismic image) and by using as seeds all or part of the pixels which correspond to local extrema of the seismic traces of the subset. Alternatively, or in combination thereof, all or part of the seeds may be manually picked by a human interpreter. For example, a human interpreter may identify and select, e.g., via a user interface, UI, unit of the computing system, pixels which are believed to be on interfaces between real stratigraphic layers, for example on either side of a presumed fault detected by the human interpreter.

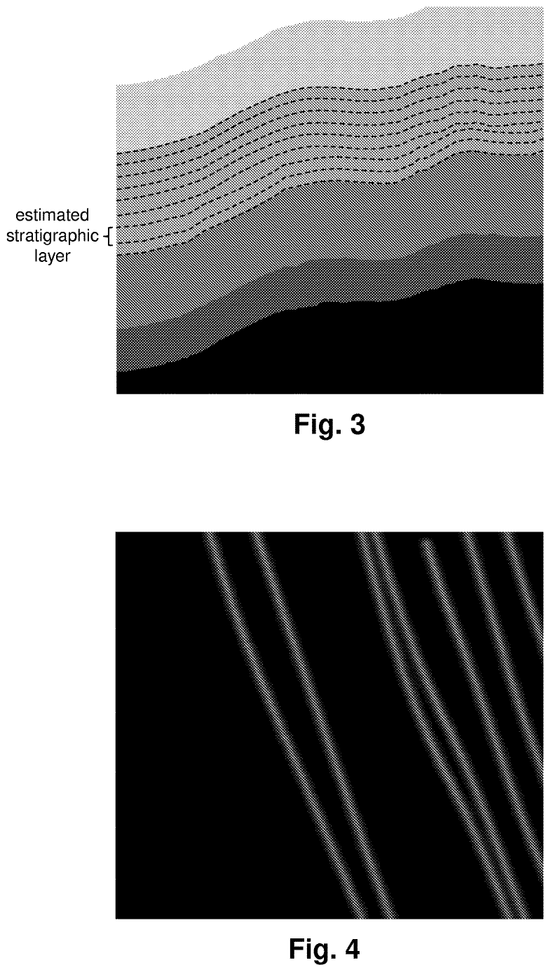

FIG. 3 represents an example of stratigraphic image obtained by processing the seismic image of FIG. 1. In FIG. 3, not all estimated stratigraphic layers are shown, for clarity purposes. Different colors are used in FIG. 3 for different groups of estimated stratigraphic layers, and the estimated stratigraphic layers of one group are represented. As can be seen in FIG. 3, despite the probable presence of faults in the geological formation, the estimated stratigraphic layers of the stratigraphic image are continuous in this example.

As illustrated by FIG. 2, the determining method 20 comprises a step S21 of splitting the estimated stratigraphic layers of the stratigraphic image into different pieces. Basically, the splitting of an estimated stratigraphic layer is carried out laterally (i.e., along the horizontal dimension) and aims at obtaining different pieces which are such that each obtained piece can be considered to belong to a single real stratigraphic layer.

In some examples, the splitting step S21 advantageously splits the estimated stratigraphic layers according to the stratigraphic discontinuity(ies) present in the geological formation. For example, the computing system may receive as input a description of each stratigraphic discontinuity of the geological formation. Such input may for example be provided at least in part by a human interpreter having analyzed the seismic image. Alternatively, or in combination thereof, the computing system may detect (automatically) the stratigraphic discontinuities by processing the seismic image. For instance, stratigraphic discontinuities may be detected by the computing system via segmentation of the seismic image. For instance, such a segmentation may be carried out by using a machine learning model, such as a (deep) neural network, previously trained to predict a likelihood value of a pixel of the seismic image belonging to a stratigraphic discontinuity. These likelihood values can for instance be compared to a threshold to keep only those pixels which likely belong to a stratigraphic discontinuity. In some cases, if the detected stratigraphic discontinuities do not extend vertically the full height of the seismic image, they can be extended to the top and bottom of the seismic image, for instance vertically extended.

Once the stratigraphic discontinuities have been detected or received as input, the computing system may split the estimated stratigraphic layers by slicing the estimated stratigraphic layers based on the (detected) stratigraphic discontinuities. Basically, in such a case, each piece of estimated stratigraphic layer may be delimited at least in part by one or more stratigraphic discontinuities.

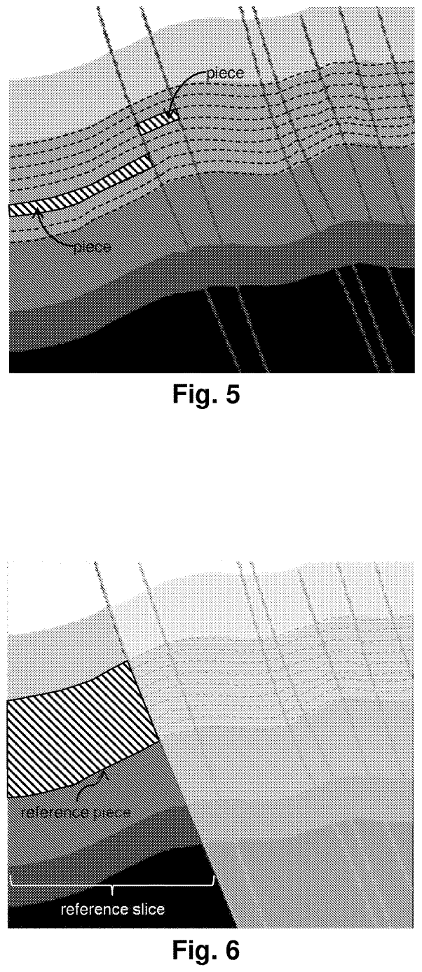

FIG. 4 represents stratigraphic discontinuities detected on the seismic image represented in FIG. 1. In this example, the stratigraphic discontinuities detected correspond to faults. As illustrated by FIG. 5, the intersection of a fault with an estimated stratigraphic layer cuts said estimated stratigraphic layer into two different pieces, i.e., the pieces of said estimated stratigraphic layer are on from either side of the fault. Of course, it is possible to consider other types of stratigraphic discontinuities for splitting the estimated stratigraphic layers. According to another example, the stratigraphic discontinuity may correspond to a salt dome, in which case a given estimated stratigraphic layer may be split into three pieces, i.e., two pieces from either side of the salt dome and one piece inside the salt dome (which may be discarded).

Based on the splitting of the estimated stratigraphic layers into pieces, a reference slice may be selected, which corresponds to a vertical stacking of pieces of estimated stratigraphic layers. For example, if the estimated stratigraphic layers are sliced based on stratigraphic discontinuities, then the reference slice may be at least partially delimited by at least one stratigraphic discontinuity of the geological formation. In FIG. 6, the stratigraphic discontinuities are faults, and the reference slice is delimited by one fault. It is emphasized that, while the reference slice appears in FIG. 6 as a 2D surface delimited by one line (representing one fault) and the border of the stratigraphic image, it corresponds preferably to a 3D volume delimited (at least in part) by surfaces which correspond to stratigraphic discontinuities, in which case the reference slice in FIG. 6 corresponds to a 2D section of the (3D) reference slice. For example, the reference slice may be set by the computing system, e.g., by selecting arbitrarily any stacking of pieces obtained after splitting, or by selecting the stacking of pieces obtained after splitting having the greatest 3D volume associated thereto, etc. According to another example, the reference slice may be selected by a human interpreter, e.g., based on an analysis of the stratigraphic image and of the seismic image. In such a case, the computing system may receive as input, via a UI unit, a description of the stacking of pieces of estimated stratigraphic layers that is to be set as the reference slice.

Basically, the reference slice is to be used as a reference for characterizing the respective contents of the real stratigraphic layers of the geological formation. The pieces of estimated stratigraphic layers of the reference slice are considered as reference pieces, which are assumed to belong to different respective real stratigraphic layers. As discussed above, by construction of the estimated stratigraphic layers, some (vertically) adjacent pieces of the reference slice may in fact belong to a same real stratigraphic layer, but this does not affect the present disclosure. However, it is also possible, in some examples, to merge together some of the (vertically) adjacent pieces of the reference slice if they can be considered to likely belong to a same real stratigraphic layer. This is the case in the non-limitative example illustrated by FIG. 6, in which the reference piece shown (as a dashed area) corresponds to the merging of a group of pieces (having a same color in FIG. 5) which are considered to likely belong to a same real stratigraphic layer. For instance, the pieces of the reference slice may be analyzed by a human interpreter who may request the computing system to merge some of the adjacent pieces of the reference slice if they are considered by the human interpreter to likely belong to a same real stratigraphic layer.

As illustrated by FIG. 2, the determining method 20 comprises a step S22 of determining a reference piece mapping model.

The goal of the determining step S22 is to build a reference piece mapping model which is capable of classifying seismic values into one of the reference pieces of the reference slice. Hence, the reference piece mapping model corresponds to a function which is configured to output (predict) a mapping, for a fragment of the geological formation, with one of the reference pieces based on input seismic values obtained for at least said fragment of the geological formation. The reference piece mapped with the considered fragment corresponds for instance to the reference piece, among all reference pieces of the reference slice, which most likely belongs to a same real stratigraphic layer as the considered fragment. In some cases, the reference piece mapping model may output respective likelihoods for all reference pieces of the reference slice, and the reference piece mapped with the considered fragment corresponds for instance to the reference piece having the greatest likelihood associated thereto.

As introduced above, the reference slice is to be used as a reference for characterizing the respective contents of the real stratigraphic layers of the geological formation. Hence, for each reference piece, the seismic values of the portion of the seismic image which corresponds to the considered reference piece are used as reference for characterizing said considered reference piece. In other words, a fragment of the geological formation for which the seismic values obtained are similar to those obtained for a reference piece may be mapped with this reference piece, i.e., the fragment will be considered to likely belong to the same real stratigraphic layer as this reference piece. Hence, the reference piece mapping model is a function configured to process seismic values in order identify the reference piece having the most similar seismic values associated thereto.

The determining step S22 may use any method for establishing a classifying or segmenting model known to the skilled person, and the choice of a specific method corresponds to a specific but non-limitative embodiment of the present disclosure.

For example, the seismic values associated to a reference piece may be used to estimate geological properties (e.g., sedimentary facies, etc.) of the corresponding portion of the geological formation. When processing the seismic values of a fragment of the geological formation, it is then possible to estimate the geological properties of said fragment which may then be compared to the respective geological properties determined for each reference piece of the reference slice.

In another non-limitative example, the reference piece mapping model corresponds to a machine learning model trained by using, as training data, the seismic values of portions of the seismic image which correspond to the reference pieces of the reference slice.

Hence, the machine learning model is trained, at least in part, via supervised learning. For each reference piece, the associated seismic values are therefore labelled with an identifier of the considered reference piece used as ground-truth data. The machine learning model is a parameterized model having tunable parameters which are iteratively updated by using the training data. During an iteration of the training, the machine learning model is applied to training data (for instance seismic values of one or more seismic traces of the reference slice) and the output of the machine learning model (labels for the processed seismic values) is compared to the corresponding ground-truth data by using a predetermined loss function. The parameters of the machine learning model are then updated in a manner that tends to optimize the loss function, by using, e.g., gradient-descent methods.

For example, the machine learning model corresponds to a neural network (NN), preferably a deep NN. In some embodiments, the machine learning model corresponds to a deep convolutional NN. For example, the machine learning model may comprise a U-Net (see, e.g., Olaf Ronneberger, Philipp Fischer and Thomas Brox, “U-Net: Convolutional Networks for Biomedical Image Segmentation”, International Conference on Medical Image Computing and Computer-Assisted Intervention, Springer, Cham, 2015. pp. 234-241, arXiv: 1505.04597.

In preferred embodiments, the machine learning model corresponds to a physics-informed neural network (PINN). Indeed, PINNs are neural networks that can embed the knowledge of physical laws that govern a given dataset in the learning process. In the present case, it is known that, in a geological formation, the (real) stratigraphic layers are arranged in a stacking order that remains the same throughout the geological formation. Indeed, in a geological formation, the geological age necessarily increases with depth, such that if a first stratigraphic layer is above a second stratigraphic layer, then this implies that the second stratigraphic layer is older than the first stratigraphic layer. Hence, if a first stratigraphic layer is above a second stratigraphic layer, then it necessarily remains above said second stratigraphic layer everywhere in the geological formation.

While some (real) stratigraphic layers may in some cases be present only locally in the geological formation (i.e., not present everywhere in the geological formation), it is not possible to have the first stratigraphic layer above the second stratigraphic layer somewhere in the geological formation and, at the same time, the second stratigraphic layer above the first stratigraphic layer elsewhere in the geological formation, since this would mean that the second stratigraphic layer is both older and younger than the first stratigraphic layer.

Hence, when mapping seismic values with reference pieces, a PINN can be trained to embed the fact that, in a geological formation, the geological age increases with depth. In such a case, the stacking order of the reference pieces in the reference slice, referred to as reference stacking order, may be used as a reference for the relative geological ages of the reference pieces. In other words, it may be assumed that the reference pieces of the reference slice are associated to different respective geological ages which are such that any reference piece below another reference piece is older than said another reference piece. Accordingly, when mapping seismic values with reference pieces, a PINN can be trained to reduce a probability of predicting mappings which result in mapping seismic values of a same seismic trace with respective reference pieces which would appear in said same seismic trace with a (predicted) stacking order that is not compatible with the reference stacking order. A predicted stacking order (i.e., the stacking order of the mappings with reference pieces predicted for a same seismic trace) is considered to be compatible with the reference stacking order if the predicted mappings with reference pieces do not contradict the relative geological ages between reference pieces, as given by the reference stacking order. In other words, the predicted stacking order is considered to be compatible with the reference stacking order if the predicted mappings do not result in a first reference piece appearing below a second reference piece while said first reference piece is considered to be younger than said second reference piece according to the reference stacking order. However, as discussed above, some (real) stratigraphic layers may not be present everywhere in the geological formation, and the predicted stacking order can be compatible with the reference stacking order even if said predicted stacking order does not reflect all the reference pieces of the reference stacking order.

With a PINN, the learning can be both supervised (as discussed above) and unsupervised since the evaluation of the compatibility of the predicted stacking order by the PINN can be carried out with seismic traces for which no ground-truth data is available or used. For the training of the PINN, it is possible to consider an additional term representative of the compatibility of the (predicted) stacking order of the predicted mappings with the reference stacking order, in order to enforce, during the training, compatibility with the reference stacking order. This additional term can be for instance included in the loss function discussed above (e.g., if the evaluation of the compatibility of the predicted stacking order is performed on the same seismic traces for which the predicted mappings are compared to the associated ground-truth data) or in a different loss function (e.g., if the evaluation of the compatibility of the predicted stacking order is performed on seismic traces that are distinct from those for which the predicted mappings are compared to the associated ground-truth data).

For example, during an iteration of the training, it is possible to apply a vertical filter to the mappings predicted successively from the top to the bottom of a seismic trace, in order to produce filtered values representative of a compatibility with the reference stacking order. For example, if the reference stacking order corresponds to an increasing stacking order, then a simple vertical filter such as [−1 1]^{T} may be used during the training to check if the predicted stacking order is compatible with the reference stacking order.

For example, the reference stacking order may be such that:
a first reference piece, on the top of the reference slice, has a label set to 0 (such that mapping with the first reference piece will output a 0),
a second reference piece, immediately below the first reference piece, has a label set to 1 (such that mapping with the second reference piece will output a 1),
a third reference piece, immediately below the second reference piece, has a label set to 2 (such that mapping with the third reference piece will output a 2), etc.

Hence, the label increases with the depth in the reference stacking order. With such a reference stacking order, during the training, filtered values equal to 0 or positive will correspond to successive predicted mappings which are compatible with the reference stacking order (since null or positive filtered values imply that the label predicted above is either equal to or lower than the label predicted below). In turn, negative filtered values will correspond to successive predicted mappings which are not compatible with the reference stacking order (since negative values imply that the label predicted above is greater than the label predicted below, which means that the successive predicted mappings occur in a reversed stacking order compared to the reference stacking order). Hence, in this example, at each iteration of the training of the PINN, the parameters of the machine learning model can be updated to reduce the occurrences of negative filtered values when filtering the successive predicted mappings obtained for one or more seismic traces of the seismic image (or to reduce the absolute value of the sum of negative filtered values, etc.). Hence, the loss function used during the learning of the PINN may for instance include a term representative of the number of occurrences of negative filtered values.

Of course, in other examples, the training of the PINN may use other conventions for describing the reference stacking order and/or for evaluating the compatibility with the reference stacking order, and other vertical filters may be used when a vertical filter is used during training to evaluate the compatibility with the reference stacking order.

As illustrated by FIG. 2, the determining method 20 applies, during a step S23, the reference piece mapping model to other pieces of estimated stratigraphic layers of the stratigraphic image. As discussed above, “other piece” means a piece that is not a reference piece, and step S23 is applied to all or part of the other pieces of the stratigraphic image. In the following, we assume in a non-limitative manner that step S23 is applied to each other piece of at least one other slice (wherein “other slice” means a slice that is not the reference slice), which may for example be a slice adjacent to the reference slice.

For each other piece of said least one other slice, the determining method 20 comprises a step S23 of mapping said other piece with one reference piece among the reference pieces of the reference slice, by applying the reference piece mapping model to at least the seismic values of a portion of the seismic image which corresponds to the considered other piece of estimated stratigraphic layer of the at least one other slice.

In some examples, the reference piece mapping model may process all seismic values obtained for a portion of the geological formation which is delimited by the considered other piece, and it may directly output a single mapping with one reference piece of the reference slice for the whole considered other piece.

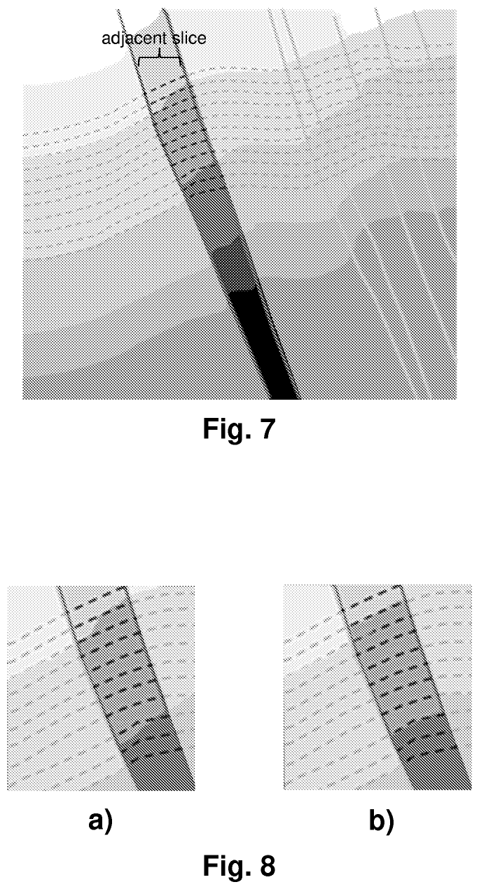

In other examples, the reference piece mapping model may process individually fragments of the geological formation, and output respective mappings for the subpieces of the stratigraphic image which correspond to these fragments. The mapping predicted for the considered other piece is then determined based on the mappings obtained for the subpieces which belong to the considered other piece. FIG. 7 represents the mappings obtained (with a PINN in this example) for subpieces of other pieces which belong to a slice that is adjacent to the reference slice (on the other side of a fault). As illustrated by FIG. 7 and by part a) of FIG. 8 which emphasizes a part of FIG. 7, the mappings obtained for the subpieces of a considered other piece are not necessarily all identical. For example, the mapping predicted for the considered other piece corresponds to the mapping predicted for the greatest number of subpieces included in the considered other piece (i.e., the mapping most frequently predicted for subpieces of the considered other piece), as illustrated by part b) of FIG. 8. Of course, other decision criteria may be taken into account. For example, the mappings predicted for the other pieces of another slice can also be determined such that they are compatible with the reference stacking order of the reference slice.

For mapping a fragment of the geological formation with a reference piece, the reference piece mapping model is applied to at least the seismic values obtained for the considered fragment. However, seismic values obtained for other parts of the geological formation, in particular parts adjacent to the considered fragment, may also be processed for predicting a mapping for the considered fragment.

For example, the reference piece mapping model may be applied to a seismic trace (i.e., a column of the seismic image) obtained for a portion of the geological formation included in the other slice. In such a case, the reference piece mapping model may output a plurality of successive mappings, obtained respectively for successive parts of the seismic trace along the vertical dimension. If the reference piece mapping model is a PINN, then the processing of the whole seismic trace may be carried out to ensure that the successive mappings, obtained respectively for successive parts of the seismic trace, are compatible with the reference stacking order of the reference slice. In such a case, the mapping predicted for a fragment of the geological formation represented by a part of the seismic trace may depend also on the seismic values of the other parts of the same seismic trace.

Once all other pieces of the at least one other slice of the stratigraphic layer have been processed, each of these other pieces is mapped with a reference piece of the reference slice, i.e., each of these other pieces is considered to belong to a same real stratigraphic layer as the reference piece it is mapped with.

As illustrated by FIG. 2, the determining method 20 comprises a step S24 of determining the stratigraphic layers of the geological formation. For each reference piece of the reference slice, a stratigraphic layer is built by grouping the considered reference piece with each other piece mapped with said considered reference piece. The stratigraphic layers determined during step S24 will typically differ from the estimated stratigraphic layers obtained during step S20, especially in the presence of stratigraphic discontinuities. Indeed, a stratigraphic layer determined during step S24 is composed of pieces which are considered by the reference piece mapping model to belong to a same real stratigraphic layer of the geological formation but said pieces can originate from different estimated stratigraphic layers determined during step S20.

As discussed above, chrono-stratigraphic analysis of a geological formation is very important for understanding and exploiting said geological formation.

For example, the stratigraphic layers determined by the determining method 20 may be displayed to a human interpreter, by using a visual display unit.

Alternatively, or in combination thereof, the computing system may use (directly or indirectly) the determined stratigraphic layers in processes of hydrocarbon recovery from the geological formation and/or in processes of carbon dioxide storage in said geological formation. In the case of hydrocarbon recovery, the computing system may use the determined stratigraphic layers to, e.g., predict an amount of hydrocarbon that may be recovered from the geological formation. In the case of carbon dioxide storage, the computing system may use the determined stratigraphic layers to, e.g., predict an amount of carbon dioxide that may be stored in the geological formation.

It is emphasized that the present disclosure is not limited to the above exemplary embodiments. Variants of the above exemplary embodiments are also within the scope of the present disclosure.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A computer-implemented method for determining stratigraphic layers of a geological formation, based on a seismic image which comprises seismic values obtained from seismic measurements carried out on the geological formation, the method comprising:
determining stratigraphic image of the geological formation by processing the seismic image, wherein the stratigraphic image corresponds to a stacking of estimated stratigraphic layers,
splitting the estimated stratigraphic layers of the stratigraphic image into different pieces and setting a reference slice composed of a stacking of pieces of estimated stratigraphic layers, referred to as reference pieces,
determining a reference piece mapping model based on the seismic values of portions of the seismic image which correspond to the reference pieces of the reference slice,
for each other piece among a plurality of other pieces of estimated stratigraphic layers: mapping the other piece with one reference piece among the reference pieces of the reference slice, by applying the reference piece mapping model to at least the seismic values of a portion of the seismic image which corresponds to the considered other piece of estimated stratigraphic layer, and
for each reference piece: determining a stratigraphic layer of the geological formation by grouping the considered reference piece with each other piece mapped with the considered reference piece.

2. The computer-implemented method according to claim 1, wherein the reference slice is at least partially delimited by at least one stratigraphic discontinuity of the geological formation.

3. The computer-implemented method according to claim 2, comprising detecting stratigraphic discontinuities of the geological formation by processing the seismic image and splitting the estimated stratigraphic layers into different pieces based on the detected stratigraphic discontinuities.

4. The computer-implemented method according to claim 2, wherein the stratigraphic discontinuities comprise faults and the reference slice is at least partially delimited by at least one fault of the geological formation.

5. The computer-implemented method according to claim 1, wherein the reference piece mapping model corresponds to a machine learning model trained by using, as training data, the seismic values of portions of the seismic image which correspond to the reference pieces of the reference slice.

6. The computer-implemented method according to claim 5, wherein the machine learning model corresponds to a neural network (NN).

7. The computer-implemented method according to claim 6, wherein the machine learning model corresponds to a physics-informed neural network; (PINN), trained to predict mappings with reference pieces which are compatible with a stacking order of the reference pieces in the reference slice, referred to as reference stacking order.

8. The computer-implemented method according to claim 7, wherein, during training, the PINN is configured to apply a vertical filter on predicted mappings with reference pieces to produce filtered values representative of a compatibility with the reference stacking order, and the PINN is trained to predict mappings with reference pieces for which the obtained filtered values are representative of a stacking order of the predicted mappings that is compatible with the reference stacking order.

9. The computer-implemented method according to claim 1, wherein mapping another piece of estimated stratigraphic layer with a reference piece comprises:
mapping a plurality of different subpieces of the other piece with respective reference pieces of the reference slice, by using the reference piece mapping model, and
determining the mapping for the other piece based on the mappings determined for the subpieces of the other piece.

10. The computer-implemented method according to claim 1, comprising using the determined stratigraphic layers for hydrocarbon recovery from the geological formation and/or for carbon dioxide storage in the geological formation.

11. The computer-implemented method according to claim 1, comprising displaying the determined stratigraphic layers by using a visual display unit.

12. A computer program product stored on computer-readable storage medium comprising instructions which, when executed by at least one processor, configure the at least one processor to carry out a method according to claim 1.

13. A computer-readable storage medium comprising instructions which, when executed by at least one processor, configure the at least one processor to carry out a method according to claim 1.

14. A computing system comprising:
at least one memory comprising executable instructions, and
at least one processor configured by the executable instructions to carry out a method according to claim 1.

15. The computer-implemented method according to claim 1, further comprising recovering hydrocarbons from the geological formation according to the determined stratigraphic layers.

16. The computer-implemented method according to claim 1, further comprising storing carbon dioxide in the geological formation according to the determined stratigraphic layers.
